(19) United States
(12) Patent Application Publication
(10) Pub. No.: US 2012/0169284 A1
(43) Pub. Date: Jul. 5, 2012

(54) Battery Charging Method and Battery Pack Using the Same

(75) Inventor: Alan Park, Yongin-si (KR)

(73) Assignee: SAMSUNG SDI CO., LTD., Yongin-si (KR)

(21) Appl. No.: 13/309,993

(22) Filed: Dec. 2, 2011

(30) Foreign Application Priority Data
Jan. 3, 2011 (KR) 10-2011-0000117

(51) Int. Cl. H02J 7/00

(52) U.S. Cl. 320/112; 320/149

(57) ABSTRACT

A battery charging method, and a battery pack using the same. In the battery charging method, constant-current charging is performed in a plurality of phases, and a magnitude of charge current with which a battery is charged is determined according to a charge amount of the battery. The charge amount may be determined by measuring the voltage of the battery or by integrating the charging current over time. When the battery charging method is used, a battery charging time is reduced and the battery is less apt to be overcharged.

### RELATED APPLICATIONS

This application claims the benefit of Korean Patent Application No. 10-2011-0000117, filed on Jan. 3, 2011, in the Korean Intellectual Property Office, the disclosure of which is incorporated herein in its entirety by reference.

### BACKGROUND OF THE INVENTION

1. Field of the Invention

One or more embodiments of the present invention relate to a battery charging method and a battery pack using the same.

2. Description of the Related Art

Increasing use of portable electronic devices, for example, mobile phones, digital cameras, or notebooks, has led to active development of batteries as a power supply source for driving the portable electronic devices. In general, a battery is provided in the form of a battery pack together with a protection circuit for controlling charging and discharging of a battery, and much research on a protection circuit is actively being performed so as to charge or discharge a battery efficiently and stably.

However, I have found that earlier methods charge a battery using a uniform current throughout an entire charging process. I have found however that this method can be inadequate it may take longer than necessary to fully charge a battery and that it also tends to overcharge the battery, thereby deteriorating the battery. What is therefore needed is a novel charging method and a novel battery pack that can carry out the method that is more time efficient and protects the battery from being overcharged.

### SUMMARY OF THE INVENTION

One or more embodiments of the present invention include a battery charging method of reducing a battery charging time, and a battery pack using the battery charging method.

Additional aspects will be set forth in part in the description which follows and, in part, will be apparent from the description, or may be learned by practice of the presented embodiments.

According to one aspect of the present invention, three is provided a battery charging method in which constant-current charging is performed in a plurality of phases, wherein a magnitude of charge current with which a battery is charged may vary according to a charge amount of the battery. The charge amount may be determined based on a state of charge (SOC) of the battery. The SOC may be calculated by integrating the charge current. The higher the SOC, the smaller the charge current magnitude. The charge amount may be determined by measuring a voltage of the battery during charging. The charging method may include a plurality of charging phases wherein the charge current may be constant within each of said phases, the charge current may decrease in steps according to each of said phases during a charging process. A boundary between adjoining ones of the phases may include a first reference voltage for changing the charge current magnitude when the voltage of the battery increases and a second and different reference voltage for changing the charge current magnitude when the voltage of the battery decreases. The first reference voltage may be larger than the second reference voltage. The higher the battery voltage, the smaller the charge current magnitude.

According to another aspect of the present invention, there is provided a battery pack that includes a rechargeable battery and a battery management unit to determine a charge amount of the battery and to control a magnitude of charging current used to charge the battery, wherein the magnitude of the charging current is held constant within each of a plurality of phases, the magnitude of charging current varies according to the charge amount of the battery. The battery pack may also include a current measurement unit to measure the charging current of the battery, the battery management unit to calculate a state of charge (SOC) of the battery by integrating the charging current over time, the charge amount of the battery being based on the SOC. The battery pack may also include a voltage measurement unit to measure a voltage of the battery during charging, the battery management unit to determine the charge amount of the battery based on the measured voltage. The battery management unit may transmit data about the charge amount of the battery to an external device, the charge current magnitude may be determined by the external device. The charging current magnitude may decrease for each successive ones of the phases.

According to still another aspect of the present invention, there is provided a method of charging a battery, including applying a first charging current to a battery, determining a charge amount of the battery by calculating a state of charge (SOC) by integrating the charging current over time; and determining whether to apply a second and lesser charging current to the battery by determining whether the SOC has reached a first threshold. The method may also include applying the second charging current to the battery upon the SOC reaching the first threshold, calculating a SOC of the battery and determining whether to apply a third and lesser charging current to the battery by determining whether the SOC has reached a second threshold.

### BRIEF DESCRIPTION OF THE DRAWINGS

These and/or other aspects will become apparent and more readily appreciated from the following description of the embodiments, taken in conjunction with the accompanying drawings of which:

FIG. 1 is a circuit diagram of a battery pack according to a first embodiment of the present invention;

FIG. 2 is a graph illustrating a charging method performed by a battery pack according to the first embodiment of the present invention;

FIG. 3 is a flowchart illustrating a charging method performed by a battery pack according to the first embodiment of the present invention;

FIG. 4 is a circuit diagram of a battery pack according to a second embodiment of the present invention;

FIG. 5 is a graph illustrating a charging method performed by a battery pack according to the second embodiment of the present invention; and

FIG. 6 is a flowchart illustrating a charging method performed by a battery pack, according to the second embodiment of the present invention.

### DETAILED DESCRIPTION OF THE INVENTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

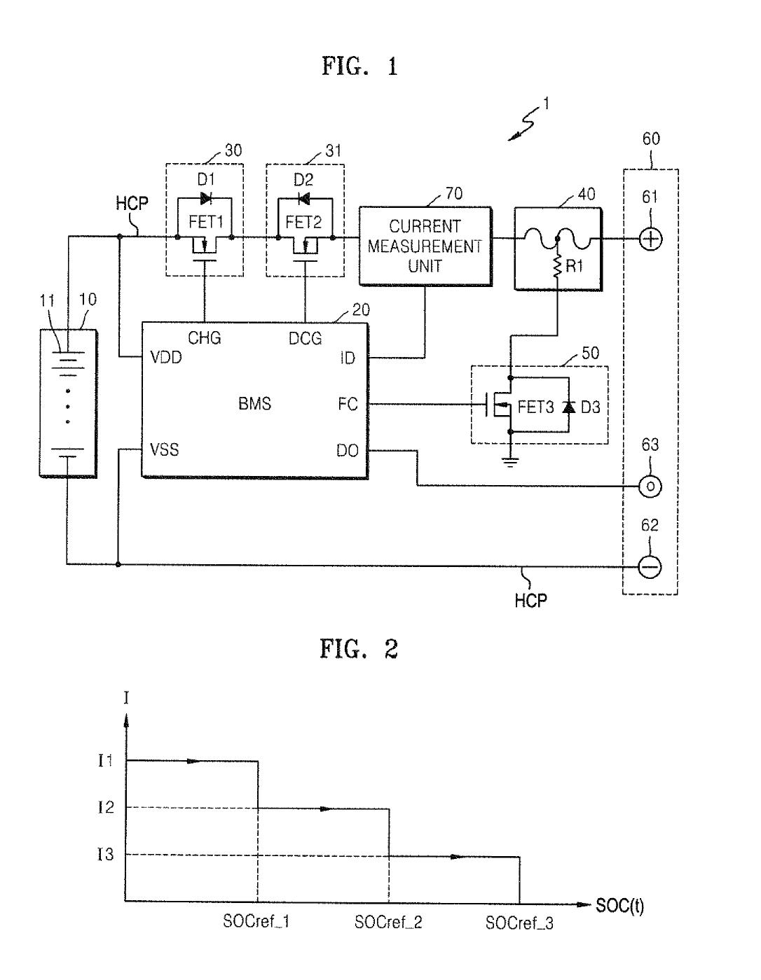

FIG. 1 is a circuit diagram of a battery pack 1 according to an embodiment of the present invention. Referring to FIG. 1, the battery pack 1 includes a battery 10, a battery management system (BMS) 20, a charge control switch 30, a discharge control switch 31, a fuse 40, a fuse control switch 50, a terminal unit 60, and a current measurement unit 70.

When an external load, such as an electrical appliance, is connected to battery pack 1, the battery 10 supplies stored power to the electrical appliance in which the battery pack 1 is to be installed. Also, if a charger is connected to the battery pack 1, the battery 10 may be charged with external power from the charger. The battery 10 may include at least one battery cell 11. The battery cell 11 may be a rechargeable secondary battery, such as a nickel-cadmium battery, a lead storage battery, a nickel metal hydride battery (NiMH), a lithium ion battery, or a lithium polymer battery.

The BMS 20 controls charging and discharging of the battery 10, and performs a balancing control on a plurality of the battery cells 11 included within the battery 10. In this first embodiment of the present invention, the BMS 20 receives a charge current magnitude, calculates a state of charge (SOC) of the battery 10 by integrating the charge current magnitude over time and determines a charge amount using the calculated SOC.

The BMS 20 may include a power terminal VDD to which a power voltage is applied, a ground terminal VSS to which a ground voltage is applied, a charge control terminal CHG, a discharge control terminal DCG, a fuse control terminal FC, a data output terminal DO, a current measurement terminal ID, etc.

When the battery pack 1 malfunctions, the BMS 20 generates a charge control signal for controlling an operation of the charge control switch 30 or a discharge control signal for controlling an operation of the discharge control switch 31. The charge control signal and the discharge control signal are respectively output to the outside through the charge control terminal CHG and the discharge control terminal DCG.

The BMS 20 generates a fuse blowing signal for blowing a fuse 40 and the fuse blowing signal is applied to the fuse control switch 50. The fuse blowing signal is output to the outside through the fuse control terminal FC.

The BMS 20 receives a charge current magnitude measured by the current measurement unit 70 through the current measurement terminal ID. Also, the BMS 20 may transmit data about a charge amount of the battery 10 along with various other data to the outside, for example, an electronic load or a charger connected to the battery pack 1, through the data output terminal DO.

The BMS 20 illustrated in FIG. 1 controls all components of the battery pack 1, but the structure of the BMS 20 is not limited thereto. For example, an analog front end (not shown) may further be included that monitors a state of the battery 10 and controls operations of the charge control switch 30 and the discharge control switch 31, and the BMS 20 may control this analog front end. When the battery pack 1 malfunctions, the charge control switch 30 blocks a charge current on the high-current path (HCP) by the control of the BMS 20, and the discharge control switch 31 blocks a discharge current on the HCP by the control of the BMS 20.

The charge control switch 30 includes a field effect transistor FET1 and a parasitic diode D1. The FET 1 is connected such that a current flowing from a positive terminal 61 to the battery 10 or a current flowing from the battery 10 to a negative terminal 62 is blocked. That is, the flow of a charge current along the high-current path (HCP) of battery pack 1 is blocked by using the FET 1. In this case, the FET 1 is formed such that a discharge current flows through the parasitic diode D1.

The discharge control switch 31 includes a field effect transistor FET2 and a parasitic diode D2. The FET2 is connected such that a current flowing from the negative terminal 62 to the battery 10 or a current flowing from the battery 10 to the positive terminal 61 is blocked. That is, the flow of a discharge current along the high-current path is blocked by using the FET2. In this case, the FET2 is formed such that a charge current flows through the parasitic diode D2. A connection direction of source and drain electrodes of the FET2 may be opposite to a connection direction of source and drain electrodes of the FET1.

Each of the charge control switch 30 and the discharge control switch 31 is a switching device and is not limited to a FET, and various other devices that perform a switching function may also be used as the charge control switch 30 and the discharge control switch 31.

The fuse 40 may be formed between the battery 10 and the terminal unit 60 on the high-current path through which a relatively high intensity of current flows. If the battery pack 1 malfunctions, the fuse 40 is blown (i.e., forms an open circuit on the HCP) to block the flow of a charge current or a discharge current. The fuse 40 includes a resistor R1 connected to the high-current path and to ground. If a current having an intensity equal to or higher than a reference magnitude flows through the resistor R1, the fuse 40 melts due to heat generated by the resistor R1, thereby blocking a current flow.

When the battery pack 1 malfunctions, first, the flow of a charge current or a discharge current is blocked by using the charge control switch 31 and/or the discharge control switch 32. However, if the malfunction of the battery pack 1 is not overcome despite the attempts to control the charge control switch 31 and/or the discharge control switch 32, the fuse 40 is blown to permanently block a current flow. That is, the battery pack 1 can never be used again when fuse 40 is blown.

The fuse control switch 50 allows a current to flow through the resistor R1 of the fuse 40 to blow the fuse 40. The fuse control switch 50 is formed between the fuse 40 and the ground, and receives a fuse blowing signal from the BMS 20 to turn on, thereby allowing a current to flow through the resistor R1. The fuse control switch 50 may include a field effect transistor FET3 and a parasitic diode D3.

The terminal unit 60 connects the battery pack 1 to an external device. In this case, the external device may be an electric appliance having an external load or a charger. The terminal unit 60 may include the positive terminal 61, the negative terminal 62 and the output terminal 63. Through the positive terminal 61, a charge current enters and a discharge current flows out. Through the negative terminal 62, a charge current flows out and a discharge current enters. Also, the terminal unit 60 includes an output terminal 63 that is connected to the data output terminal DO of the BMS 20 to transmit data to the external device. This transmitted data outputted through output terminal 63 can include a charge amount of the battery 10, a control signal or other data.

The current measurement unit 70 is also arranged on a high-current path and measures a charge current flowing into the battery 10. The current measurement unit 70 applies a measured charge current magnitude to the BMS 20.

The current measurement unit 70 illustrated in FIG. 1 is connected to and interposed between the discharge control switch 31 and the fuse 40 along the high-current path, however the position of the current measurement unit 70 is exemplary. That is, the current measurement unit 70 may instead be located at any location as long as a charge current flowing into the battery 10 can be accurately measured. Also, in the battery pack 1 of FIG. 1, the measurement unit 70 and the BMS 20 are separately formed, however, in another embodiment, the current measurement unit 70 may be included within the BMS 20.

Turning now to FIG. 2, a charging method performed by the battery pack 1 according to the first embodiment will now be described in detail. FIG. 2 is a graph illustrating a charging method performed by the battery pack 1 showing charging current Iₙ on the ordinate (vertical) axis and state of charge (SOC) of the battery on the abscissa (horizontal) axis.

Referring now to FIG. 2, the battery 10 is charged by using a constant-current charging method including a plurality of phases, each having different charge current magnitudes. The charge current magnitude used in each of the phases may be determined according to a charge amount of the battery 10. In the first embodiment, the charge amount of the battery 10 may be determined using a SOC calculated by the BMS 20, SOC being a time integral of the current (i.e., SOC(t)=∫I(t)dt).

In detail, in a first phase in which charging begins, constant-current charging is performed with a first charge current I1. When the SOC of the battery 10 reaches a first reference SOCref_1, the first phase is converted to a second phase and constant-current charging is performed with a second and lesser charge current I2. Also, when the SOC of the battery 10 reaches a second reference SOCref_2, the second phase is converted to a third phase and constant-current charging is performed with a third and still lesser charge current I3. This first embodiment described in association with FIG. 2 includes three charging phases, however the number of charging phases may vary. For example, the number of charging phases may be four or more and still be within the scope of the present invention.

As described above, the battery 10 is charged by using a constant-current charging method including a plurality of phases, and the intensity of a charge current is reduced in steps as the SOC (i.e., ∫I(t)dt) decreases. In this case, the BMS 20 may directly control the charge current. Alternatively, the BMS 20 may transmit data about a charge amount of the battery 10 to an external device, for example, an electric apparatus or a charger in which the battery pack 1 is to be installed, through the output terminal 63, and the electronic apparatus or charger that receives the data may control the magnitude of a charge current supplied to the battery pack 1.

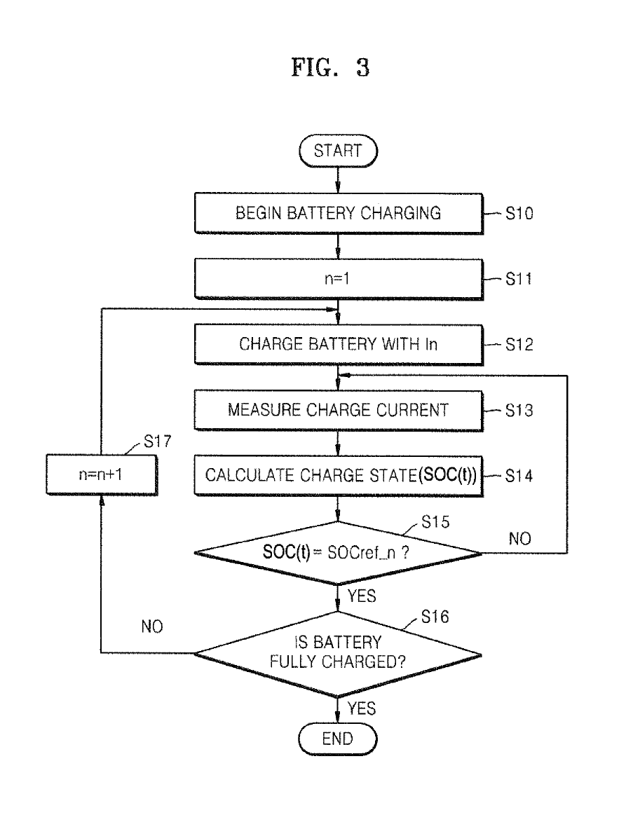

Turning now to FIG. 3, FIG. 3 is a flowchart illustrating a charging method performed by the battery pack 1 according to the first embodiment of the present invention. Referring to FIG. 3, when the battery pack 1 is connected to a charger, the BMS 20 begins the charging of the battery 10 (S10). When the charging begins, n is set to unity (1) (S11).

When charging begins, constant-current charging is performed with a first charge current I1 during a first phase (S12). The current measurement unit 70 measures a charge current that continuously flows into the battery 10 after charging begins (S13). The BMS 20 calculates a current SOC(t) of the battery 10 with reference to the measured charge current magnitude and time of charging (S14).

The BMS 20 determines whether the calculated SOC(t) reaches a first reference SOCref_1 (S15). If the SOC(t) has not yet reached the first reference SOCref_1 in S15, the charging operation continues unchanged at S13. On the other hand, if the SOC(t) has reached the first reference SOCref_1 in S15, it is then determined whether the battery 10 is fully charged (S16). For example, if the battery 10 undergoes constant-current charging in three phases and the SOC(t) reaches a third reference SOCre_f3, it is considered that the battery 10 is fully charged. However, the full charge condition for the battery 10 is exemplary, and may vary.

If it is determined that the battery 10 has not yet fully charged at S16, n is incremented by 1 (S17) and the operation S12 is then performed, that is that the charging continues, but at a lesser magnitude In after having incremented n by 1. Then, the operations S12 through S16 are repeatedly performed to carry out two or three constant-current charging phases.

In earlier battery charging systems, when the battery 10 is charged through a single constant-current charging phase, an excess current may enter the battery 10 at the last stage of charging, thereby deteriorating the battery. If the battery 10 is charged by constant-current charging and constant-voltage charging, a constant-voltage charging time at the last stage of charging is long. Also, if the battery 10 is charged by pulse charging, a high voltage is applied to the battery 10 and a high current flows into the battery 10 in a short time period, the lifetime of the battery 10 may be reduced, and a plurality of the battery cells 11 may become imbalanced.

In the battery pack 1 according to the first embodiment of the present invention, the battery 10 is charged by using a constant-current charging method including a plurality of phases. In this case, as a SOC increases, a charge current magnitude is reduced. Thus, the charging time may be reduced while a stress applied to the battery 10 is minimized.

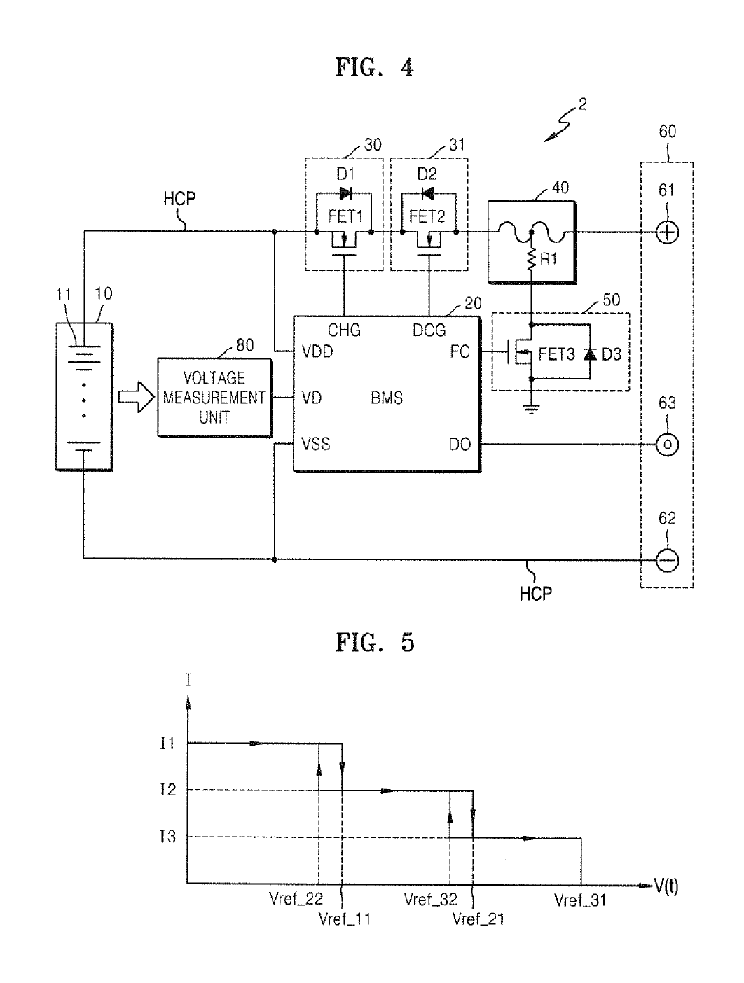

Turning now to FIG. 4, FIG. 4 is a circuit diagram of a battery pack 2 according to a second embodiment of the present invention. Many of the components of the battery pack 2 and the corresponding components of the battery pack 1 of FIG. 1 have substantially the same functions and thus a detailed description of said similar components will not be repeated here. Accordingly, only a difference between the battery pack 2 of FIG. 4 and the battery pack 1 of FIG. 1 will now be described in detail.

Referring now to FIG. 4, the battery pack 2 includes a battery 10, a BMS 20, a charge control switch 30, a discharge control switch 31, a fuse 40, a fuse control switch 50, a terminal unit 60, and a voltage measurement unit 80. The voltage measurement unit 80 measures a voltage of the battery 10 and applies the measured voltage magnitude to the BMS 20.

The BMS 20 receives the voltage magnitude measured by the voltage measurement unit 80 through a voltage measurement terminal VD, and varies the charging current magnitude according to the measured voltage magnitude. For example, if the voltage of the battery 10 is 4.2 V, it is determined that the battery 10 is fully charged, and if the voltage of the battery 10 is 3.5 V, it is determined that the battery 10 is fully discharged but that the charging current needs to be decreased in order to complete the charging process.

Although FIG. 4 shows the voltage measurement unit 80 and the BMS 20 as being separately formed, the battery pack 2 may instead be constructed so that the BMS 20 includes the voltage measurement unit 80 within.

Hereinafter, a charging method performed by the battery pack 2 will be described in detail in conjunction with FIG. 5. FIG. 5 is a graph illustrating a charging method performed by the battery pack 2 according to the second embodiment of the present invention, whereby the charging current In varies according to the voltage of the battery 10 instead of the SOC(t) of the battery.

Referring to FIG. 5, the battery 10 is charged by using a constant-current charging method including a plurality of phases having different charge current magnitudes. A charge current magnitude used in each of the phases may be determined according to charge amount of the battery 10. In the second embodiment, the charge amount of the battery 10 is determined using a voltage magnitude measured by the voltage measurement unit 80.

In detail, in a first phase in which charging begins, constant-current charging is performed with a first charge current I1. If a voltage of the battery 10 reaches a first reference voltage Vref_11, the first phase is converted to a second phase and constant-current charging is performed with a second and lesser charge current I2. Also, when the voltage of battery 10 should rise to first reference voltage Vref_21 in the second phase, the second phase is converted to a third phase and constant-current charging is performed with a third and still lesser charge current I3. This embodiment described in association with FIG. 5 includes three charging phases, however the number of charging phases may vary. For example, the number of charging phases may be four or more and still be within the scope of the present invention.

Meanwhile, when the first phase is converted to the second phase, the voltage of the battery 10 may temporarily decrease due to a decrease in a charge current from the first charge current I1 to the second charge current I2. If this occurs in the second embodiment, the constant-current charging phase may revert from the second phase back to the first phase, and constant-current charging may be repeatedly performed between the first phase and the second phase. The second and third phases have the same relationship as that between the first and second phases in that it is possible to revert back to the second phase from the third phase should the voltage of the battery 10 fall below second reference voltage Vref_32.

Accordingly, in the second embodiment of the present invention, each of the phases has a second reference voltage Vref_n2 for reverting a charging phase back to the previous phase, and if the voltage of the battery 10 is reduced to reach the second reference voltage Vref_n2, the charging phase is reverted to the previous phase. That is, a hysteresis period is present at a boundary between two adjoining phases for converting a charging phase is present between the first reference voltage Vref_n1 and the second reference voltage Vref_n2.

As described above, the battery 10 is charged by using a constant-current charging method including a plurality of phases, and the intensity of the charge current in each of the phases is decreased as the voltage of the battery 10 increases. Also, a reference voltage for converting a charging phase when the voltage of the battery 10 increases and a reference voltage for reverting a charging phase when the voltage of the battery 10 decreases are set differently to prevent an unnecessary conversion of a charging phase.

In this second embodiment, the BMS 20 may directly control the charge current. Alternatively, the BMS 20 may transmit data about a charge amount of the battery 10 to an external device, for example, an electronic device or a charger in which the battery pack 2 is to be connected with, and the electronic device or charger that receives the data through the output terminal 63 of terminal unit 60 of battery pack 2 may control the magnitude of a charge current supplied to the battery pack 2.

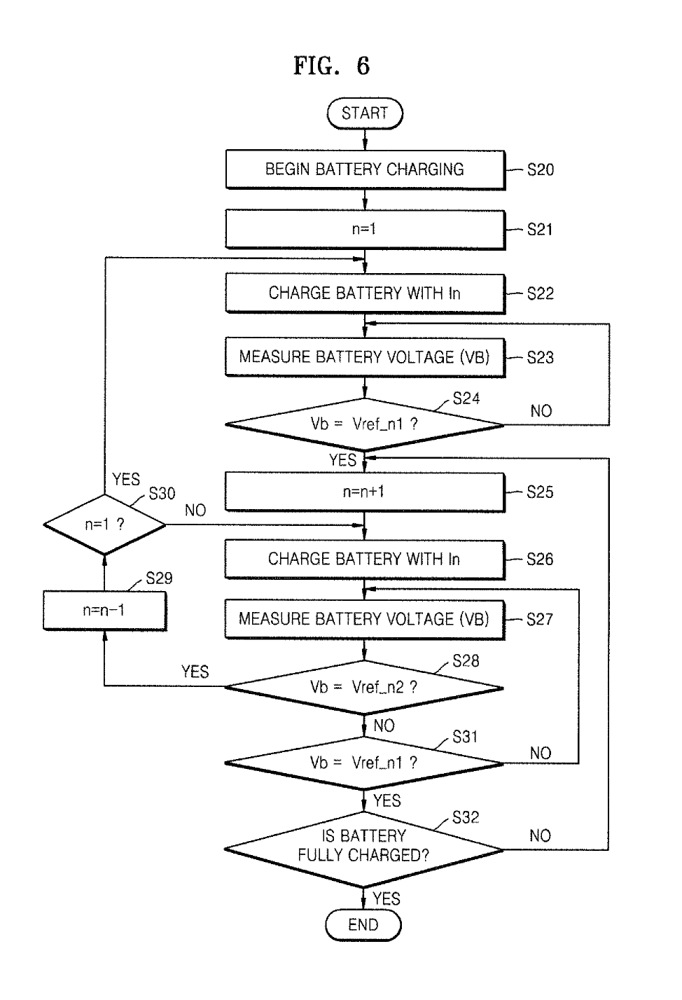

Turning now to FIG. 6, FIG. 6 is a flowchart illustrating a charging method performed by the battery pack 2. Referring now to FIG. 6, if a charger is connected to the battery pack 2, the BMS 20 begins charging the battery 10 (S20). When charging begins, n is set to unity (1) (S21).

When charging begins, constant-current charging is performed with a first charge current I1 in a first phase (S22). The voltage measurement unit 80 measures a voltage of the battery 10 during the charging after charging begins (S23). The BMS 20 determines charge current magnitude of the battery 10 with reference to the measured voltage magnitude (S24).

The BMS 20 determines whether the measured voltage magnitude Vb of the battery 10 reaches a first reference voltage Vref_11 in the first phase (S24). If the measured voltage magnitude Vb of the battery 10 has not yet reached a first reference voltage Vref_11 in the first phase in S24, the charging operation continues unchanged at S23. On the other hand, if Vb reaches the first reference voltage Vref_11 in S24, n is incremented by 1 (S25). By doing so, the charge phase is converted to a next phase. In the second phase, constant-current charging is performed with a second and lower charge current I2 (S26).

Upon conversion to a subsequent phase, the voltage measurement unit 80 continuously measures the voltage of the battery 10 (S27) to determine whether the Vb should happen to fall to a second reference voltage Vref_22 while in the second phase (S28). If the Vb falls to the second reference voltage Vref_22 in the second phase, n is decremented by 1 (S29) and then the charging reverts back to previous charging phase. Upon doing so, it is first determined whether n=1 (S30), and if n=1, the operation S22 is performed, and if n does not equal 1, the operation S26 is performed.

If the Vb does not fall to the second reference voltage Vref_22 upon transitioning to the second phase in S28, it is then determined whether the Vb has increased to a first reference voltage Vref_21 in the second phase (S31). If it is determined that the Vb has not reached the first reference voltage Vref_21 in the second phase in S31, the charging operation continues unchanged at S27.

On the other hand, if it is determined that the Vb reaches to the first reference voltage Vref_21 in the second phase in S31, it is determined whether the battery 10 is fully charged (S32). For example, if the battery 10 is charged by using a constant-current charging method including three phases and the Vb reaches a first reference voltage Vref_31 in a third phase, it may be determined that the battery 10 is fully charged. However, the full charge condition for the battery 10 is exemplary and may vary. Meanwhile, if it is determined that the battery 10 has not yet been fully charged in S32, the operation S25 is performed.

In the second embodiment, the operations S25 through S31 are performed to carry out the second phase, but the phase performed through the operations S25 through S31 are not limited thereto. That is, according to phase conversion performed through the operations S25 through S32, the phase performed through the operations S25 through S31 may be for a third phase or higher.

As described above, if the battery 10 is charged by using one constant-current charging phase, by constant-current charging and constant-voltage charging, or by pulse charging, various problems may occur. However, in the battery pack 2 according to the second embodiment, the battery 10 is charged by using a constant-current charging method including a plurality of phases. In this case, as a voltage increases, a charge current magnitude is reduced. Thus, the charging time may be reduced while a stress applied to the battery 10 is minimized.

As described above, according to the one or more of the above embodiments of the present invention, if the battery charging methods and the battery packs using the methods described above are used, a battery charging time may be reduced and the battery is less apt to be stressed or damaged.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A battery charging method in which constant-current charging is performed in a plurality of phases, wherein a magnitude of charge current with which a battery is charged varies according to a charge amount of the battery.

2. The battery charging method of claim 1, wherein the charge amount is determined based on a state of charge (SOC) of the battery.

3. The battery charging method of claim 2, wherein the SOC is calculated by integrating the charge current.

4. The battery charging method of claim 2, wherein the higher the SOC, the smaller charge current magnitude.

5. The battery charging method of claim 1, wherein the charge amount is determined by measuring a voltage of the battery during charging.

6. The battery charging method of claim 1, wherein the charge current is constant within each of said phases, the charge current decreasing in steps according to each of said phases during a charging process.

7. The battery charging method of claim 6, wherein a boundary between adjoining ones of the phases comprises:
a first reference voltage for changing the charge current magnitude when the voltage of the battery increases; and
a second and different reference voltage for changing the charge current magnitude when the voltage of the battery decreases.

8. The battery charging method of claim 7, wherein the first reference voltage is larger than the second reference voltage.

9. The battery charging method of claim 5, wherein the higher the battery voltage, the smaller the charge current magnitude.

10. A battery pack, comprising:
a rechargeable battery; and
a battery management unit to determine a charge amount of the battery and to control a magnitude of charging current used to charge the battery, wherein the magnitude of the charging current is held constant within each of a plurality of phases, the magnitude of charging current varies among different phases according to the charge amount of the battery.

11. The battery pack of claim 10, further comprising a current measurement unit to measure the charging current of the battery, the battery management unit to calculate a state of charge (SOC) of the battery by integrating the charging current over time, the charge amount of the battery being based on the SOC.

12. The battery pack of claim 10, further comprising a voltage measurement unit to measure a voltage of the battery during charging, the battery management unit to determine the charge amount of the battery based on the measured voltage.

13. The battery pack of claim 10, the battery management unit to transmit data about the charge amount of the battery to an external device, the charge current magnitude being determined by the external device.

14. The battery pack of claim 10, the charging current magnitude decreasing for each successive ones of the phases.

15. A method of charging a battery, comprising:
applying a first charging current to a battery;
determining a charge amount of the battery by calculating a state of charge (SOC) by integrating the charging current over time;
determining whether to apply a second and lesser charging current to the battery by determining whether the SOC has reached a first threshold.

16. The method of claim 15, further comprising:
applying the second charging current to the battery upon the SOC reaching the first threshold;
calculating a SOC of the battery; and
determining whether to apply a third and lesser charging current to the battery by determining whether the SOC has reached a second threshold.
